(19) United States
(12) Patent Application Publication
(10) Pub. No.: US 2018/0128002 A1
(43) Pub. Date: May 10, 2018

(54) Floodgate

(71) Applicant: Parafoil Design & Engineering Pte Ltd, Singapore (SG)

(72) Inventor: Jwee Thiam QUEK, Singapore (SG)

(21) Appl. No.: 15/564,367

(22) PCT Filed: Apr. 21, 2015
(86) PCT No.: PCT/SG2015/050078

§ 371 Date: Oct. 4, 2017

(51) Int. Cl. E04H 9/14; E06B 9/04

(52) U.S. Cl. CPC E04H 9/145; E05F 15/53; E06B 9/04

(57) ABSTRACT

A floodgate is provided. The floodgate has a panel configured to be movable between an opened position and a closed position wherein in the opened position, the panel forms a barrier against flood water. First and second extendable members coupled to the panel exert a force to move the panel from the closed position towards the opened position about at least one hinge. A deactivation mechanism is operable to deactivate the first extendable member when the panel is moved from the closed position towards the opened position, thereby reducing force exerted by the first extendable member against the panel when the panel is moved from the opened position towards the closed position.

### FIELD AND BACKGROUND

This invention relates to a floodgate.

Flooding (e.g. due to increased rainfall) may cause widespread damage to property, infrastructure and the economy. Floodgates (or flood barriers) are an effective measure for preventing floods from entering an infrastructure (for example, a building or an underground car park) in addition to existing drainage systems. In particular, during a flood, a floodgate in the form of a panel is erected to form an obstruction to protect the infrastructure from the ingress of the flood water. For example, a floodgate is described in PCT/SG2010/000376, which uses gas struts to exert a force to move a floodgate panel to an opened position from a closed position. In particular, the gas strut exerts a sufficiently large force to raise and hold the panel (which is typically very heavy) in place.

However, floodgates may impose safety risks during their use, especially in a case of an emergence such as a building fire etc. In such circumstances, the erected floodgate panel may obstruct exits of the building and hinder the evacuation process.

Therefore, it is desirable to provide an improved floodgate to address the above concern.

### SUMMARY OF INVENTION

In general terms, the invention proposes a floodgate with a plurality of extendable members for moving a floodgate panel from a closed position towards an open position, and that at least one of the extendable members is operable to be deactivated so that the force exerted by the extendable members against the panel is reduced during a closure of the panel. This makes it possible to require only a much smaller force in order to close the floodgate panel from the opened position and therefore allows people within the infrastructure to gain access to the exterior, especially in case of an emergency.

Specifically, in an aspect of the invention, there is provided a floodgate having a panel configured to be movable between an opened position and a closed position wherein in the opened position (typically but not necessarily vertical or substantially vertical in use), the panel forms a barrier against flood water. The floodgate further has first and second extendable members coupled to the panel to exert a force to move the panel from the closed position towards the opened position about at least one hinge and a deactivation mechanism operable to deactivate the first extendable member when the panel is moved from the closed position towards the opened position, thereby reducing a force exerted by the first extendable member against the panel when the panel is moved from the opened position towards the closed position.

This is advantageous because a smaller force is needed to counter the force exert by the extendable members which are pressing against the panel when it is desired to close the panel (i.e. moving the panel from the opened position towards the closed position). For example, this allows the panel to be manually closed by building occupiers easily and conveniently thereby providing exits for evacuation in case of emergency. Furthermore, the floodgate panel may be operated (both opening and closing) manually without requiring any power supply, which may be cut off during heavy rain or floods.

In one embodiment, the deactivation mechanism is operable to cause the first extendable member to cease exerting a force (as compared to reducing the force) against the panel when the panel is moved from the opened position towards the closed position. For example, the deactivation mechanism operates to disengage the first extendable member from the panel. For example, if the first extendable member is a gas strut, the deactivation mechanism may be configured to cause one end of the gas strut which is attached to the panel to be disconnected from it.

In one embodiment, the deactivation mechanism causes the first extendable member to disengage from the panel upon the panel being raised to a pre-determined position between the closed position and the opened position. The pre-determined position may be proximate to the opened position, such as a position which is at less than 10 degrees or 5 degrees from the opened position. For example, once the panel has been raised to a position of up to about 85 degrees from the ground (when the floodgate is installed into a generally horizontal ground area). In this case, the first extendable member may be disengaged from the panel simply by falling into the ground area or near a frame of the floodgate under the influence of gravity once its attachment to the panel has been released by the deactivation mechanism, for example.

In one embodiment, the floodgate may have a plurality of the first extendable members. For example, two gas struts may be arranged on the panel symmetrically about the second extendable member. This allows the reduction in force exerted on the panel to be easily balanced upon the two gas strut being disengaged from the panel (if they were exerting the same amount force against the panel prior to the disengagement).

Preferably, the floodgate further comprises a safety mechanism arranged with the panel to reduce a speed at which the panel moves from the opened position towards the closed position. This prevents any abrupt closure of the panel (which is typically very heavy) and mitigates a risk of potential injury to people as a result. For example, this would prevent a person standing adjacent to the floodgate (especially those near a base frame of the floodgate, such as near an edge of the frame which is distal from the hinge when the panel is in the closed position) from being crushed if the panel is accidentally and/or abruptly closed.

In one embodiment, the safety mechanism comprises a third extendable member operable to become energized to exert a force against the panel when the panel is moved towards the closed position. For example, the third extendable member may comprise a gas strut having a first end attached to the panel, and a second end which comes into contact with a catch when the panel is moved towards the closed position.

In one embodiment, the safety mechanism is operable to exert a force against the panel to support the panel at an intermediate position. For example, as the gas strut becomes energized (e.g. compressed between the panel and the catch), a force is exerted by the gas strut against the leading surface of the panel thereby holding the panel in place, before the panel is completely closed. The panel may then be closed completely by manually exerting a force (for example, by a body weight of an adult as he/she steps onto the panel). This ensures that the panel is closed by a two-step action to further reduce the risk of injuries and/or damages as a result of an accidental initiation of a closure of the panel. Importantly, this compensates any safety concerns which may arise due to a reduction in the amount of required force for initiating the closure of the panel.

### BRIEF DESCRIPTION OF DRAWINGS

It will be convenient to further describe the present invention with respect to the accompanying drawings that illustrate possible embodiments of the invention. Other embodiments of the invention are possible, and consequently the particularity of the accompanying drawings is not to be understood as superseding the generality of the preceding description of the invention.

FIG. 1(a) and FIG. 1(b) are perspective views of a floodgate according to an embodiment in a closed and an opened condition (i.e. when the floodgate panel is erected), respectively.

FIG. 2(a) is a top view of the floodgate in an opened condition.

FIG. 2(b) is a section view of the floodgate in an opened condition along an axis C-C of FIG. 2(a).

FIG. 3(a) is a top view of a floodgate in a closed condition.

FIG. 3(b) is a section view of the floodgate in a closed condition along an axis A-A of FIG. 2(a).

FIG. 3(c) is a section view of the floodgate in a closed condition along the axis C-C of FIG. 2(a).

FIG. 4(a) and FIG. 4(b) are section views of a floodgate showing a step of deactivating the first extendable members of the floodgate, as viewed from an axis D-D of FIG. 2(b) and the axis C-C of FIG. 2(a), respectively.

FIG. 4(c) is a perspective view of the floodgate of FIG. 4(a).

FIG. 5 shows the first extendable members of the floodgate right after a step of deactivating the first extendable members.

FIG. 6 shows the floodgate according to an embodiment being raised to the opened position after the step of deactivating the first extendable members as shown in FIGS. 4(a) and 4(b).

FIG. 7(a), FIG. 7(b), FIG. 7(c) and FIG. 7(d) show an instruction signage being revealed when the floodgate panel is in the opened position, according to an embodiment.

FIG. 8 is a section view of the floodgate along the axis C-C of FIG. 2(a) as the panel is moved towards the closed position.

FIG. 9(a) and FIG. 9(b) are cut-away views of the floodgate along an axis X-X in FIG. 6 as the panel is moved from an intermediate position (FIG. 9(a)) towards the closed position (FIG. 9(b)).

FIG. 10(a) and FIG. 10(b) are top views of a floodgate system according to an embodiment in a closed and an opened condition, respectively.

FIG. 10(c) is an enlarged view of portion C of FIG. 10(b).

FIG. 11(a) and FIG. 11(b) are perspective views of the floodgate system showing a step of deactivating the first extendable member of the floodgate system, as viewed from an axis A-A of FIG. 10 (a).

FIG. 12 is a rear axonometric view of the floodgate system in a closed state.

FIG. 13(a) and FIG. 13(b) are perspective views of the floodgate in (a) a predetermined position between a fully erected position and a closed position, and (b) a fully erected position, respectively.

FIG. 14(a) and FIG. 14(b) are perspective views of the floodgate in (a) an intermediate position, and (b) a closed position.

FIG. 14(c) is a cut-away view of the floodgate along an axis Y-Y in FIG. 14(a).

### DETAILED DESCRIPTION

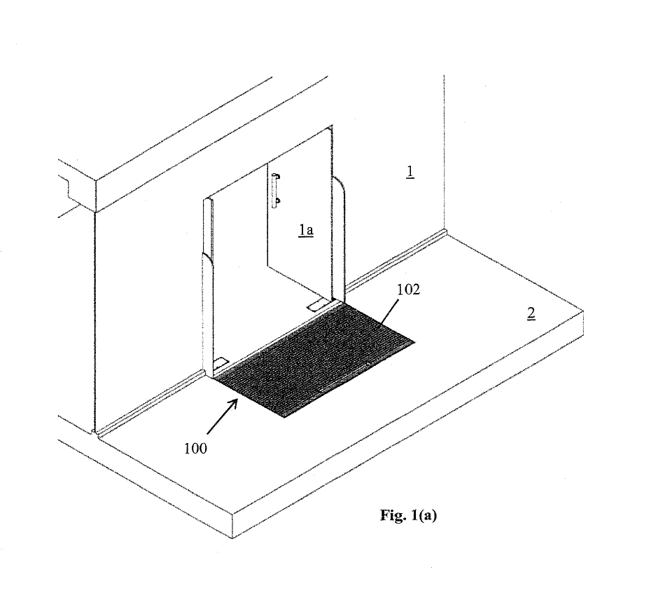

FIGS. 1(a) and 1(b) show a floodgate 100 installed at a building entrance for protection against intruding flood water. In this example, the building entrance is provided as a fixed glazing or masonry wall 1 with at least a door leaf la pivotable about the wall 1. FIG. 1(a) shows the floodgate 100 in a closed position, in which the floodgate 100 is flush with the ground or floor 2 of building to serve as unobstructed passageways for pedestrians during normal use. FIG. 1(b) shows the floodgate 100 in an opened position in which the panel 102 of the floodgate 100 is erected (for example, fully to a vertical position) thereby forming a barrier against the ingress of flood water. The panel 102 may be in concrete, tiled, or floor mat finish.

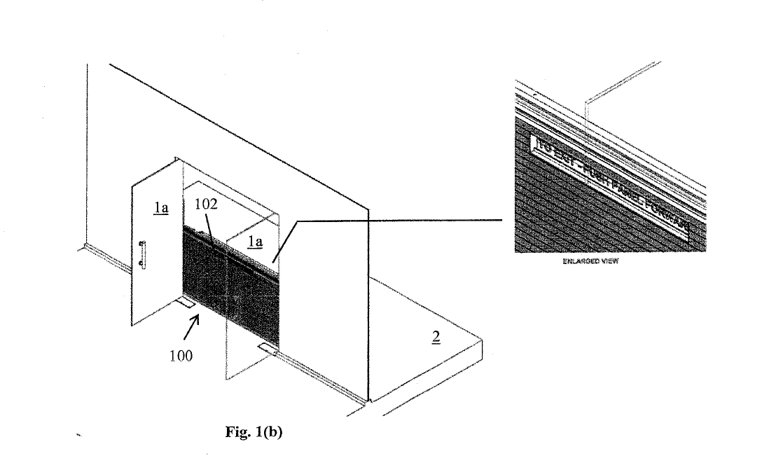

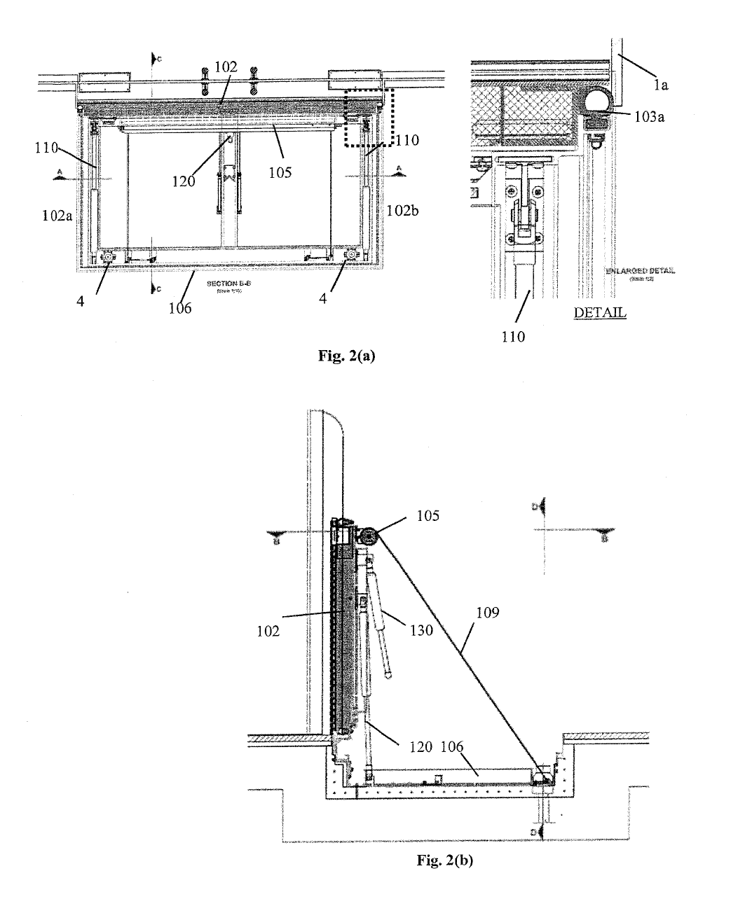

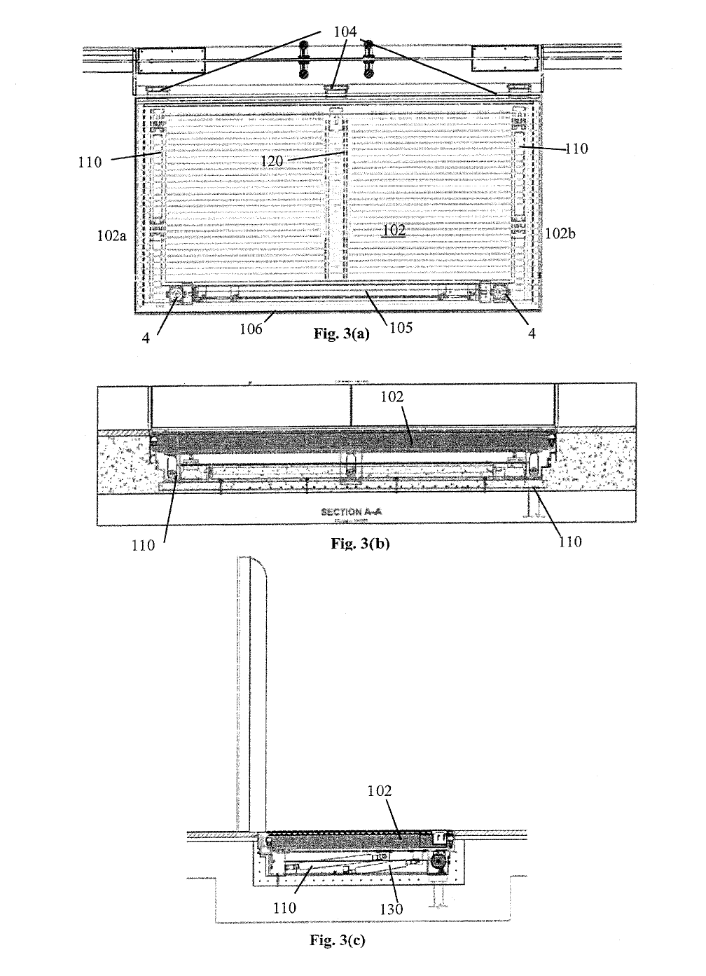

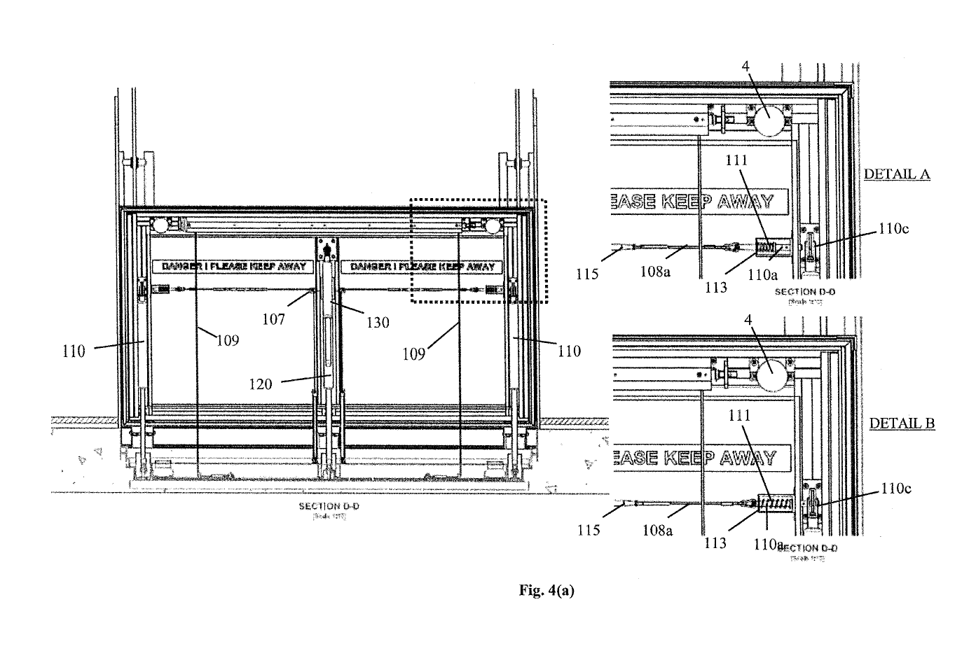

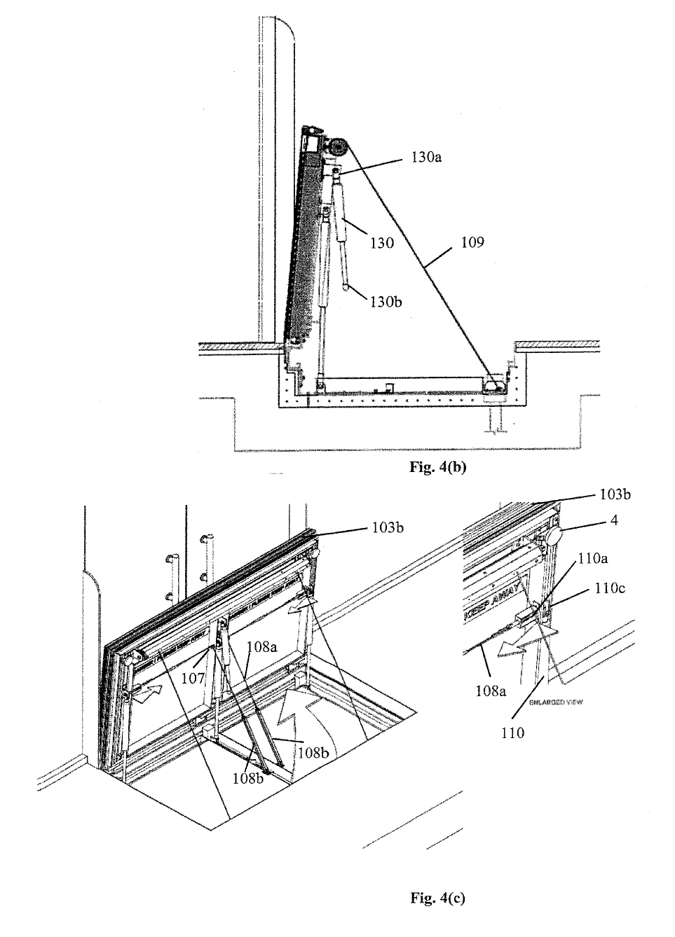

Referring to FIGS. 2(a)-(b) and FIGS. 3(a)-(c), the floodgate 100 comprises gas struts 110, 120 for moving the panel 102 between an opened position and a closed position about hinges 104 (such as SUS304 hinges). Two gas struts 110 are disposed adjacent to two opposing lateral edges 102a, 102b of the panel 102, respectively, so as to exert forces near the edges 102a, 102b of the panel. Sealing elements 103 are provided at the edges 102a, 102b of the panel 102 which extend along the edges 102a, 102b such that the panel 102 is in sealing contact with respective objects (edges of a panel of an adjacent floodgate) located in close proximity with the edges 102a, 102b of the panel 102. In this example, the panel 102, when in the erected position, forms a water-tight seal with glazed fin of the door leaves 1a (or edges of the wall or door frame).

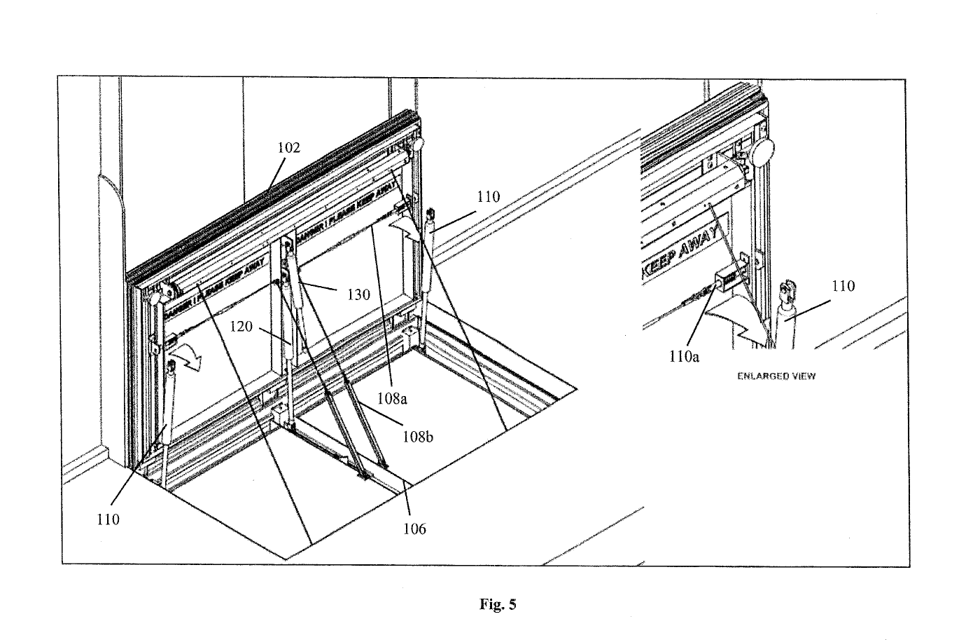

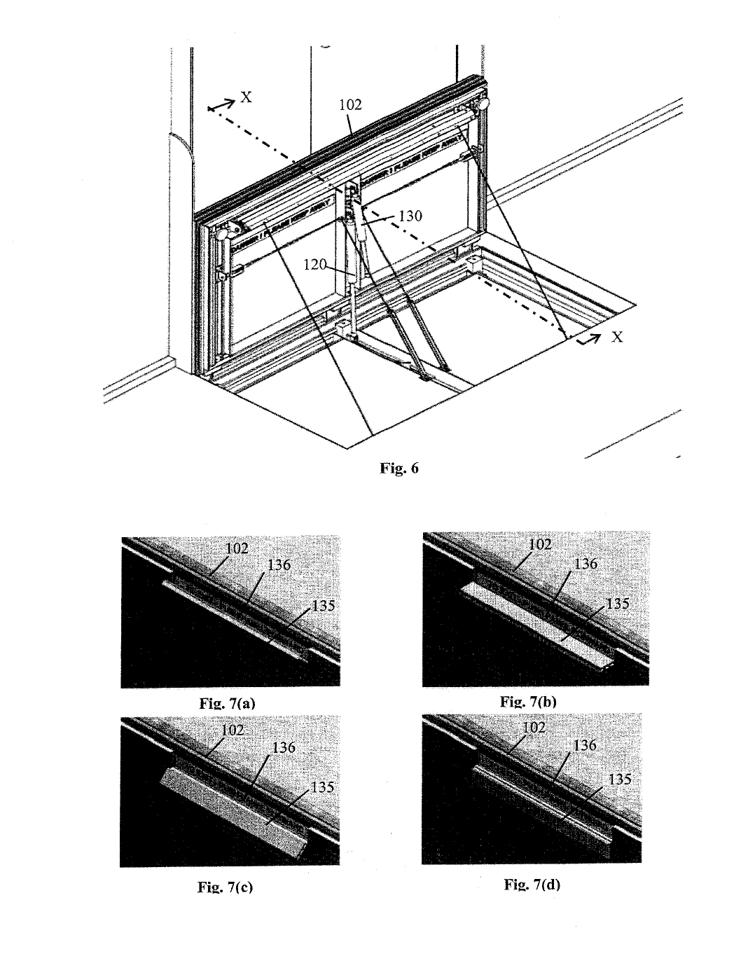

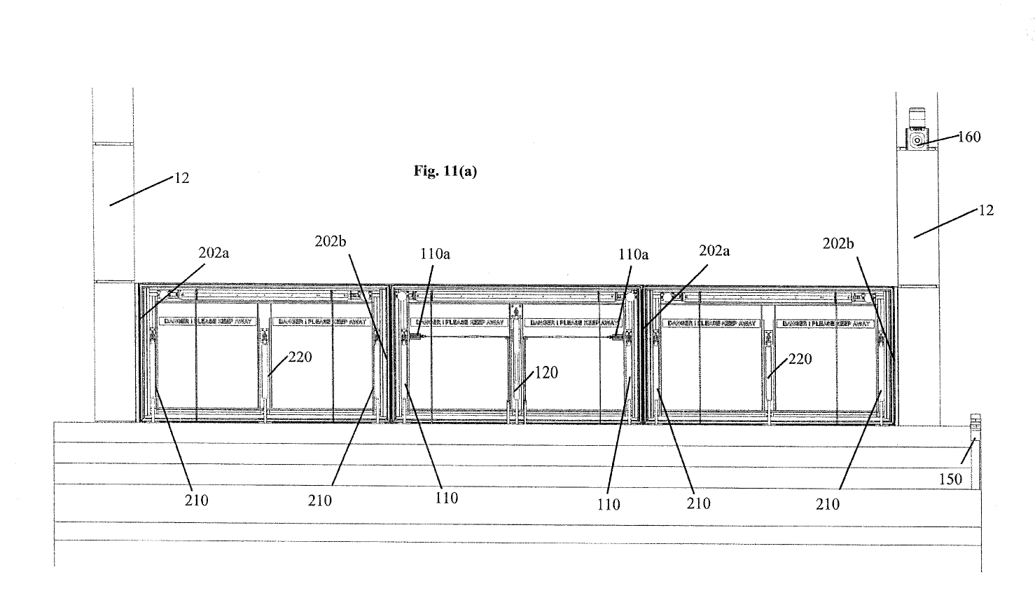

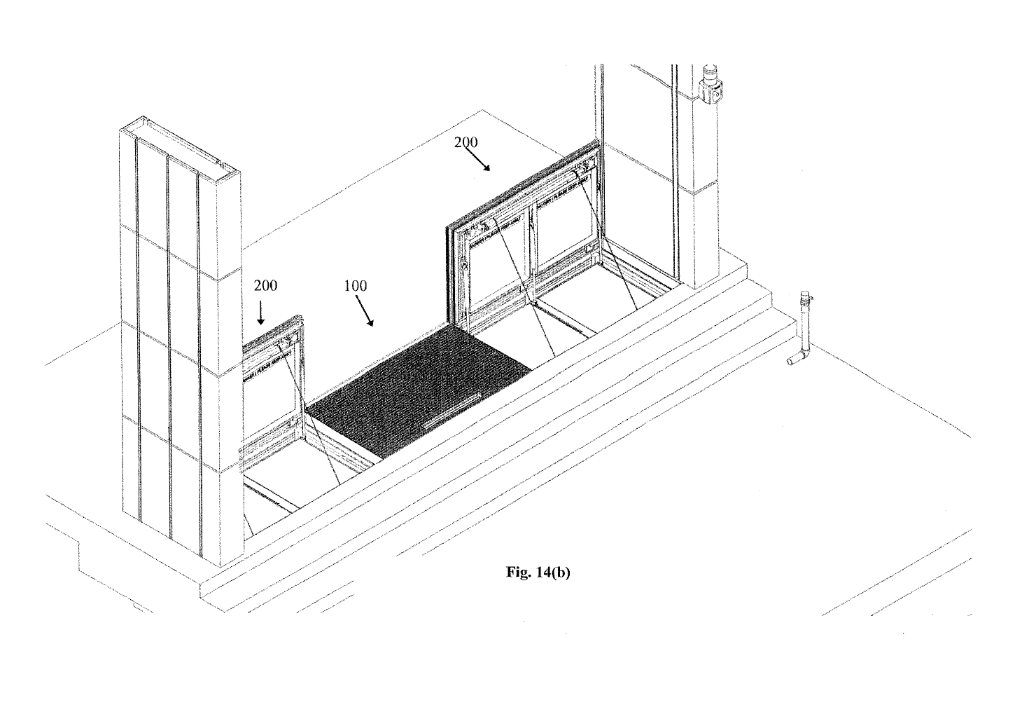

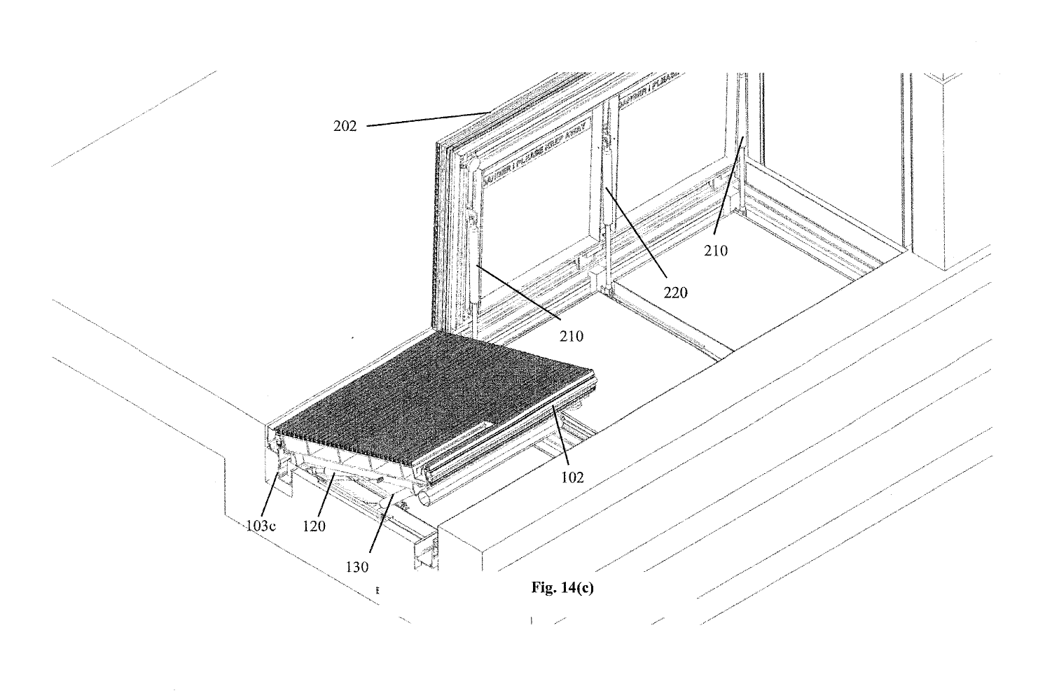

Sealing elements 103b (FIG. 4(c) and FIGS. 9(a) and 9(b)) may be provided at other parts of the floodgate panel, such as along the edge of the panel 102 about which the panel 102 pivots and its opposite edge (i.e. the edge of the panel which is distal to the hinge and parallel to the hinge axis. Further sealing elements 103c (see FIG. 14(c)) may be provided at a part or all of the base frame 106 to maintain watertightness between the floodgate 100 and the installation location). In the above examples, the sealing elements 103a, 103b, 103c are vulcanizable corrugated EPDM seals. Another gas strut 120 is arranged with the panel 120 to exert a force along the centerline of the panel 102. Each of the gas struts is a set of elongate members (usually two members) which are relatively slidable (e.g. by a telescoping motion) between a compressed configuration and an extended configuration. The gas strut includes a trapped amount of gas which is compressed in the compressed configured and urges the gas strut into the extended configuration, as described in PCT/SG2010/000376, the entire content of which is hereby incorporated by reference.

Each of the gas struts 110, 120 is configured to move the panel 102 from the closed position to the opened position. Each of the gas struts 110, 120 comprises a first portion in the form of a piston and a second portion in the form of a cylinder. The cylinder is filled with gas and the piston is movable within the cylinder. When the panel 102 is locked in the closed position, each of the gas struts 110, 120 is at the minimum length and the gas in the cylinder of each gas strut is pressurized or energized. This pressure results in a force exerted against the closed panel 102. The panel 102 may be locked in the closed position by locking members 4 such as electromagnetic (EM) locks. For example, the EM locks 4 are configured to be switchable between a locked state and an unlocked state such that when the EM locks 4 are activated, the EM locks lock the panel 102 in the closed position and when the EM locks are deactivated or released, the panel 102 moves toward the opened position as a result of the force exerted by the gas struts 110, 120. More than one locking member may be used.

When the floodgate is opened, the panel 102 is unlocked and the gas struts 110, 120 exert a force against the panel 102 to push against the panel 102 thereby moving the panel 102 towards the opened position. In this example, two opposing ends of the gas struts are respectively connected to the panel 102 and the ground (via a base-frame 106 of the floodgate 100). The base-frame 106 may be an Aluminum base frame. The interior space defined by the base-frame 106 may comprise concrete-infill. The required magnitude of the force exerted by each of the gas struts 110, 120 depends on the weight of the panel. In other words, a heavier panel (which is stronger to withstand a higher weight of traffic, for example, when the floodgates 100 are to be installed at an entrance of an underground car-park) typically requires a greater force to be exerted by the gas struts to move the panel 102.

In some embodiments, a rotatable drive 105 (e.g. a tubular drive) is provided to assist the movement of the panel 102 from the opened position to the closed position. In one example, the rotatable drive 105 is mounted at one edge of the panel 102 and is connected to the base frame 106 via ropes 109. In use, as the rotatable drive 105 rotates, the panel moves towards the closed position as a result of the force exerted via the ropes 109. The rotatable drive 105 may be powered electrically. Note that the rotatable drive 105 is optional, rather than essential. A rotatable drive for use with a floodgate is described in PCT/SG2010/000376, the entire content of which is hereby incorporated by reference. Referring to FIGS. 4(a)-4(c), as the gas struts 110, 120 move the panel 102 towards the opened position, a deactivation mechanism is activated to disconnect one end of each of the gas struts 110 from the panel 102 thereby causing the gas struts 110 to cease exerting a force against the panel 102. In this particular example, the deactivation mechanism is activated upon the panel 102 having been raised to a pre-determined position, for example, about 80-85 degrees from the horizontal (as shown in FIG. 4(c)). This may be implemented by, for example, providing spring-tensioned extractor pins which withdraw automatically thereby disconnecting one end of the gas struts 110 from the panel 102, when the panel 102 is raised to the pre-determined position, as explained below.

As shown in the enlarged views of FIGS. 4(a) and 4(c), gas strut fork pins 110a are mounted on the panel for movement parallel to the length direction of the hinge. The gas strut fork pins 110a are biased by compression springs 111 against an extraction housing 113 attached to the panel 102 into an extended position in which they extend through a respective guide slot 110c in a bracket attached to the panel, and into an aperture (e.g. a gas strut fork) at the upper end of the gas strut 110, such that the connect the panel 102 to the upper end of the gas strut 110 (Detail B of FIG. 4(a)). However, they are automatically retracted to release the engagement between the gas struts 110 and the panel 102, as wires 108a attached thereto are pulled (Detail A of FIG. 4(a)). The gas strut fork pins 110a and the wires 118a may be connected by a snap link . The wires 108a may be any type of wire configured to withstand a force for retracting the gas strut fork pins without breaking, for example, the wires 108a may be stainless steel wire ropes of 4 mm in diameter (e.g. a M4 SUS 304 wire rope). As shown in FIG. 4(c), one end of the wires 108a is attached to the gas strut fork pins 110a and the other end is coupled to the base frame 106 or to the ground, optionally via a guide 108b (such as a guide bar) for guiding the wire 108a. Therefore, as the panel 102 rises from the closed position, the wires 108a start to experience tensile forces as the distance between the panel and the ground increases and this leads to the gas strut fork pins 110a being retracted from the slots 110c through which the gas struts 110 engage (or are attached to) the panel 102. Accordingly, deactivation mechanism may cause the gas struts 110 to disengage from the panel 102 upon the panel 102 being raised to a pre-determined position between the opened position and the closed position. This may be achieved by, for example, adjusting the length and/or resilience of the wires 108a. A control member 115 (such as a rigging swage and terminal) may be provided for adjusting the length of the wires 108a. In this example, the wires 108a are configured to pull the gas strut pins 110a along a direction parallel to the panel 102 (and also parallel to an edge of the panel 102), rather than along a direction directly connecting the gas strut pins 110a and the ground. This can be achieved by redirecting the wire 108a through a connecting component 107 on the panel 102 before connecting it to the ground. The connecting component 107 may be positioned at any location with respect to the panel 102 to redirect the pulling force of wire 108a to facilitate an easy and efficient operation of the deactivation mechanism 108. In this example, the connecting component 107 is a roller (or a pulley) which is attached to the panel 102. The roller is positioned such that two segments of wire 108a are respectively located at either side of the roller are orthogonal to each other.

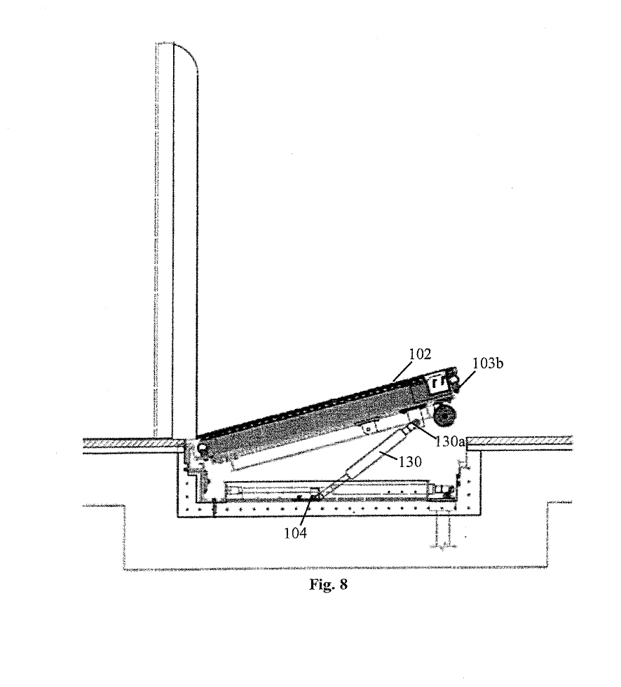

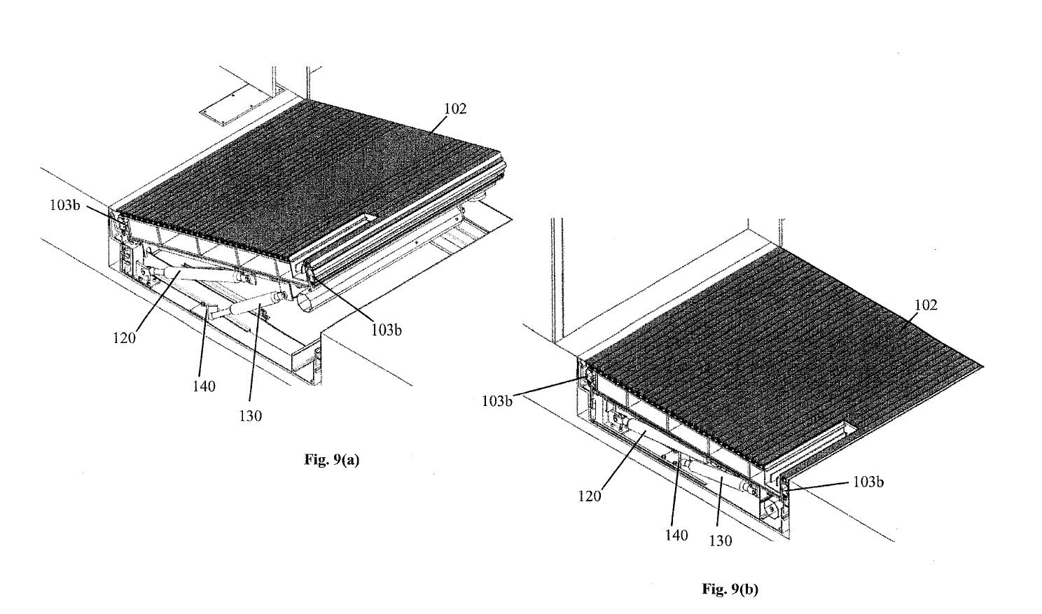

As shown in FIG. 5, once the gas strut fork pins 110a are pulled to release the attachment of the gas struts 110 to the panel 102, the gas struts 110 fall towards the ground (e.g. fall into the base frame 106 in this case). In order words, the gas struts 110 cease to exert a force against the panel 102. The panel 102 continues being raised to and held at a fully erected position (such as vertical or substantially vertical) by the gas strut 120. Since the force required for continuing to raise the panel 102 from the pre-determined position to the opened position is typically much smaller than that required for raising the panel 102 from the closed position to the pre-determined position, the force required of the gas strut 120 is sufficient on its own. It is therefore possible to rely on the gas strut 120 only (rather than all three gas struts 110, 120) to continue raising the panel to the opened position (as shown in FIG. 6). In this example, the gas strut 120 is configured to exert a smaller magnitude of force than each of the gas struts 110.

Alternatively, the deactivation mechanism can be configured to become activated to disconnect one end of each of the gas struts 110 from the panel 102 upon the panel 102 having been raised to a fully erected position (e.g. vertical or substantially vertical). In that case, the gas struts 110 may or may not automatically fall into the base frame 106 or the ground upon the disconnection. Nonetheless, during the subsequent closure of the panel 102, the gas struts 110 would cease to exert a force against the panel since the end of the gas strut has been disconnected. In one embodiment, the gas struts 110 fall into the base frame under gravity upon the panel 102 being pushed forward.

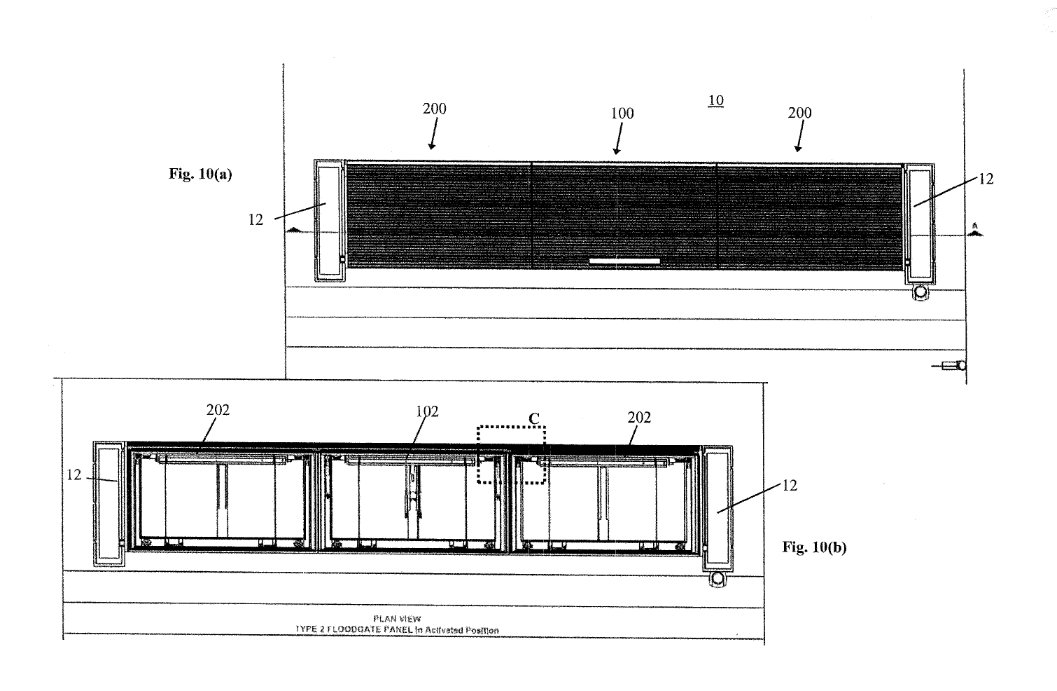

The panel 102 may be configured to reveal an instruction signage for closing the panel 102 when the panels 102 are in the opened position. This is shown in FIG. 1(b) and FIGS. 7(a)-7(d)), in which the face of the panel away from the struts 110 (the “outer” face) is provided with a flap 135. When the panel is in the lowered position, the flap 135 lies in the plane of the outer face of the panel, and flat against the sign 136, but when the panel is raised to the opened position, the flap 135 folds forward under gravity to reveal the sign 136.

To initiate a closure of the panel 102 during an evacuation, the panel 102 may be pushed forward manually. Since the gas struts 110 having been disengaged from the panel 102 (therefore ceasing to exert any force against the panel), the manual force required to counter the force of the gas strut in order to close the panel 102 will be much smaller. In one example, the forward force to push the floodgate panel 102 towards the closed position is only 235N (i.e. the weight of 24 kg) whereas the force to open the floodgate panel 102 from the normally recessed position (i.e. the closed position) is 2983N for a 1.0 m×1.0 m floodgate panel when the weight of the floodgate panel is 179 kg. Therefore, the public and/or building occupiers are able to manually collapse the floodgate panels 102 easily in case of an emergency where an evacuation of the public is needed. Once the panel 102 is pushed to deviate from the opened position, the weight of panel gradually takes over to counter the force exerted by the gas strut 120 to continue moving the panel towards the closed position.

Another way of closing the panel 102, returns it to the state depicted in the Enlarged View B of FIG. 4(a). That is, the panel is closed to a position which is lower than the predetermined position. Then the free ends of the gas struts 110 are reattached to panel 102 using the gas strut force pins. Then the panel is lowered to the closed position. Doing this requires much more force than the first way of closing the panel mentioned in the previous paragraph, but readies the floodgate 100 to be deployed again when needed.

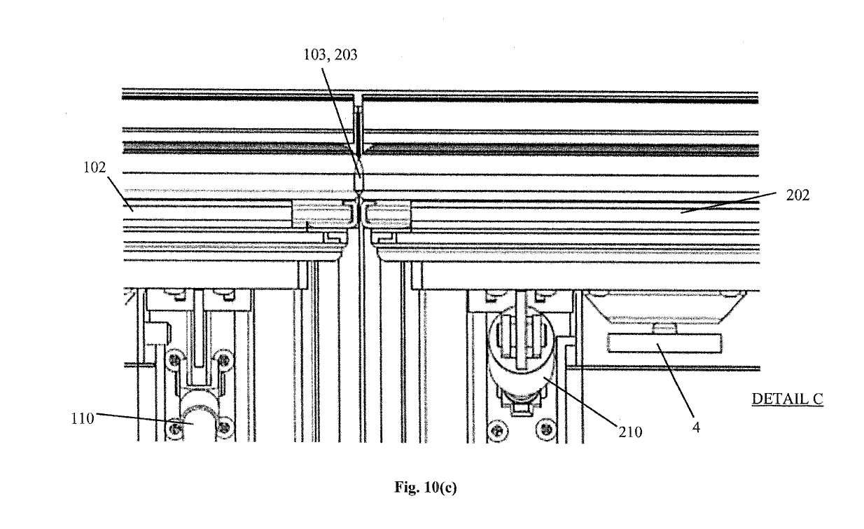

In one embodiment, the floodgate 100 comprises a further gas strut 130 for reducing a speed at which the panel 102 is moved from the opened position towards the closed position. The gas strut 130 is configured with respect to the floodgate 110 such that it is deactivated (i.e. does not exert a force against the panel 102) when the panel 102 is in the opened position and becomes activated (or energized) when the panel 102 is moved towards the closed position. In this embodiment, the gas strut 130 has a first end 103a attached to the panel 102 and a second end 130b. The gas strut is dimensioned such that when the gas strut 130 is in its fully extended state, the second end 130b remains free from any abutment when the panel is in the opened position (FIGS. 4, 5 and 6). FIGS. 9(a) and 9(b) are cut-away views of the floodgate 100 along an axis X-X in FIG. 6, as the panel 102 is moved towards the closed position. The gas strut 130 is arranged with the panel 102 such that it becomes energized to support the panel 102 at an intermediate position between the opened and closed position (as shown FIG. 8 in which the gas strut 120 is not shown). In this case, the gas strut 130 is configured to come into contact with a catch 140 configured to abut the second end 130b of the gas strut 130 thereby exerting a force against the panel 102 upon being compressed between the panel 102 and the catch 140. In this particular example, the gas strut 130 is configured to exert a force against the leading (i.e. inner) surface of the panel 102 so as to stop the panel 102 from continuing moving towards the closed position due to the weight of the panel 102. For example, the edge of the panel 102 which is opposite to the hinges 104 is maintained at about 300 mm above the floor level. Upon a further external force being exerted against the panel 102 to overcome the force exerted by the gas strut 130, the panel 102 moves from the intermediate position to the closed position and is held in the locked state by the locking member discussed earlier. The further external force may be provided by one or more adults (e.g. by evacuees) stepping onto the panel 102. Once the panel 102 is in the locked state, the rest of the building occupiers can be evacuated through the unobstructed passageway safely. Advantageously, the gas strut 130 not only functions as a safety mechanism during the closure of the panel 102, but also assists in the initial lifting of the panel 102 from the closed position to the opened position too. This reduces the force required from the gas strut 110, 120. For example, when no rotatable drive is used to close the panel, this will assist the panel to be manually opened. Additionally, since the gas strut 130 remains deactivated during the initial closure of the panel 102, it helps reduce the manual force required to push the panel 102 in order to initiate the closure of the panel 102.

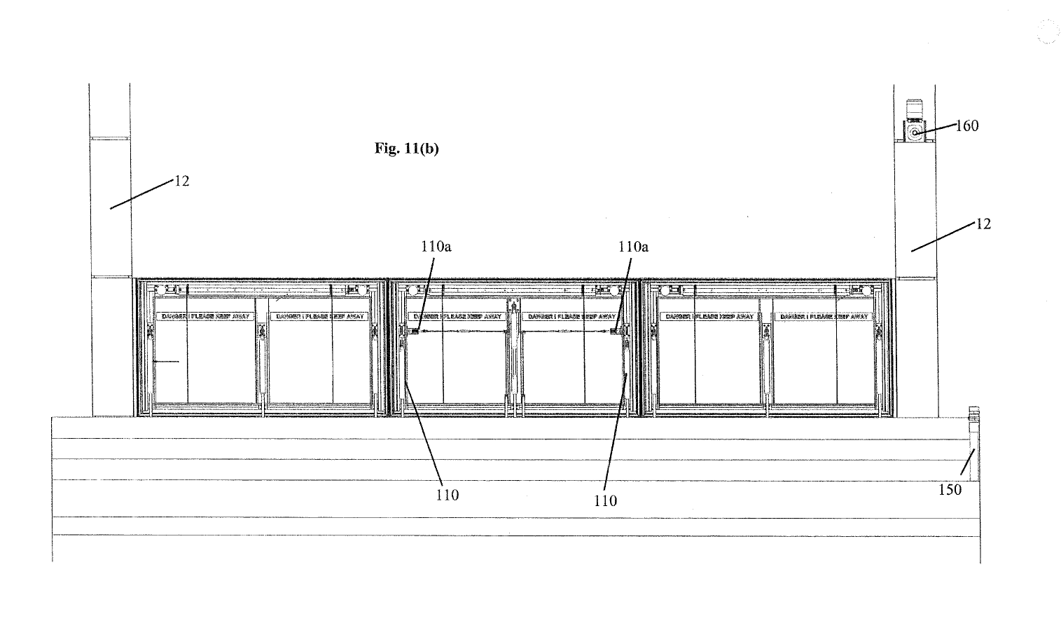

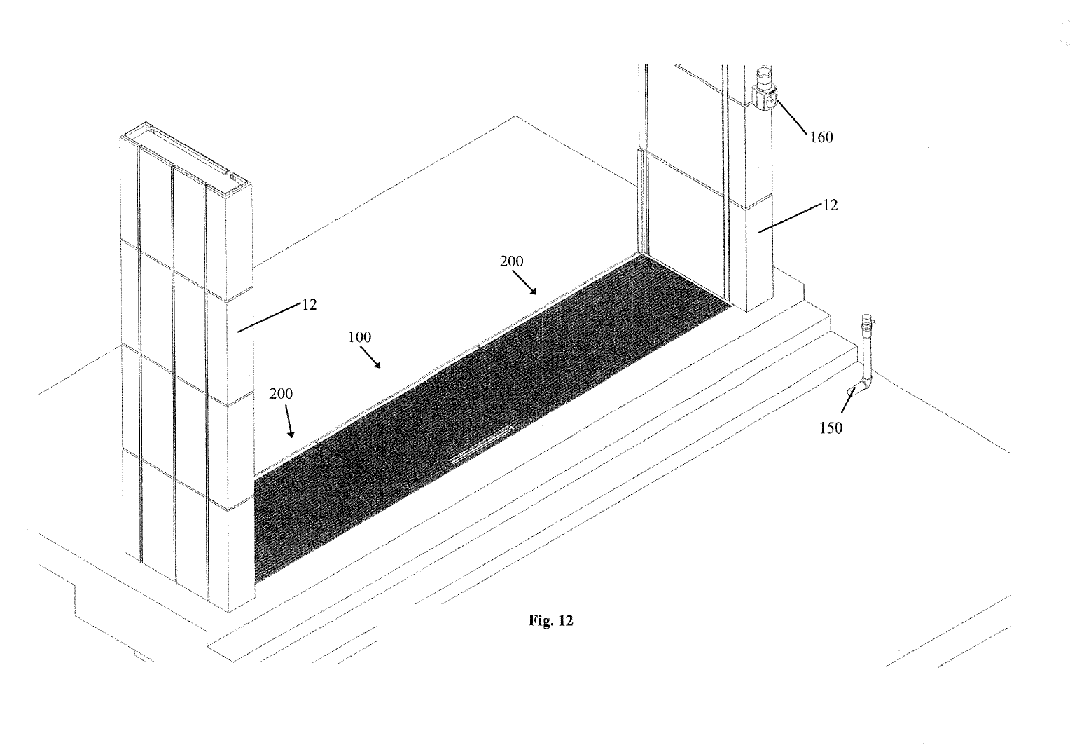

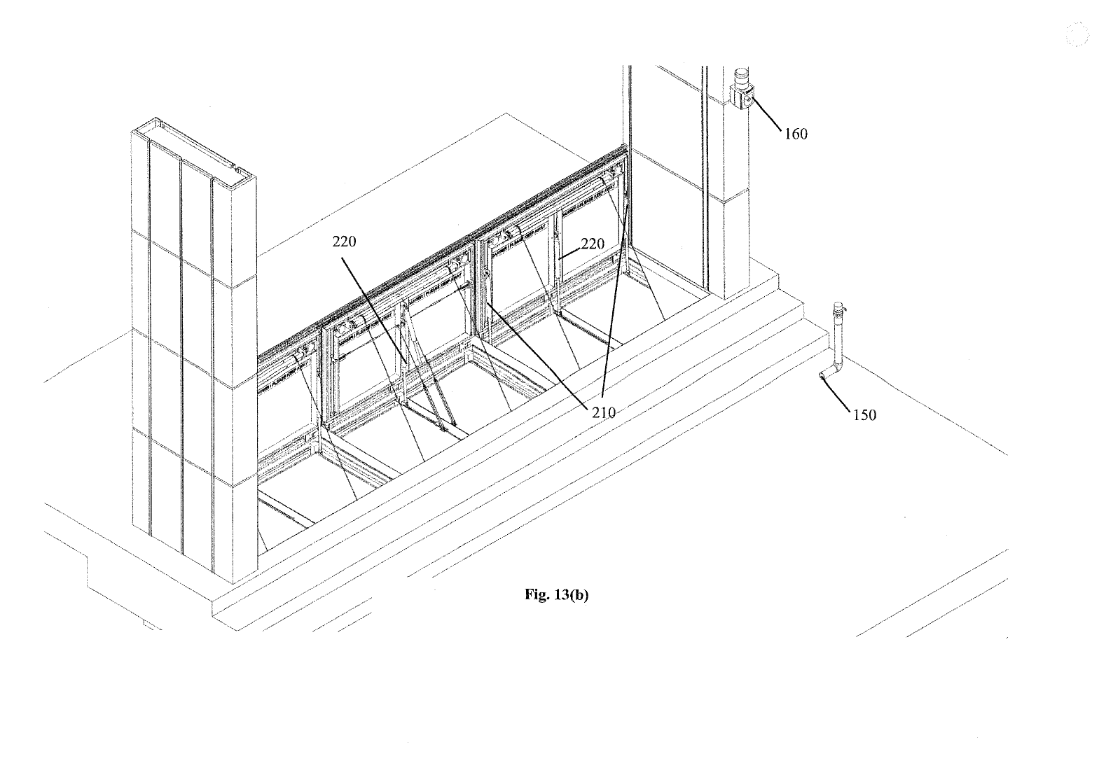

FIGS. 10-12 show a floodgate system 10 according to another embodiment. The floodgate system 10 comprises a plurality of floodgates 100, 200 arranged in series such that the respective floodgate panel 102, 202 are erected to form a continuous barrier against the ingress of flood water upon the floodgate system 10 being activated. A first floodgate 100 is identical to the floodgate 100 described in the earlier embodiments. In this embodiment, the first floodgate 100 is disposed in between two second floodgates 200 which are respectively proximate two opposing side walls 12 of a building entrance. Similarly to the floodgate 100, each of the two second floodgates 200 has two gas struts 210 disposed adjacent to two opposing lateral edges 202a, 202b of the panel so as to exert forces near the edges 202a, 202b of the panel. Each of the two second floodgates 200 similarly has a further gas strut 220 arranged with the panel to exert a force along the centerline of the panel 202. In another embodiment, the arrangement of the plurality of floodgates 100, 200 may not be linear, that is, the floodgates may not be oriented to the same direction or parallel directions. In that case, the floodgate panels, when erected, are in different vertical planes at an angle to one and another, while still forming a continuous barrier against the flood water. The second floodgates 200 are different from the first floodgate 100 in that the second floodgates 200 do not have a deactivation mechanism for disengaging the gas struts from the floodgates 200 and causing the gas struts to cease to exert a force against the panel when the panel is moved towards the closed position Similar to the floodgate 100, sealing elements 103, 203 are provided at the edges which extend along the edges the panels 102, 202 and are in sealing contact to maintain water-tightness (FIG. 10(c)). In this example, the sealing elements 103 are vulcanizable corrugated EPDM seal.

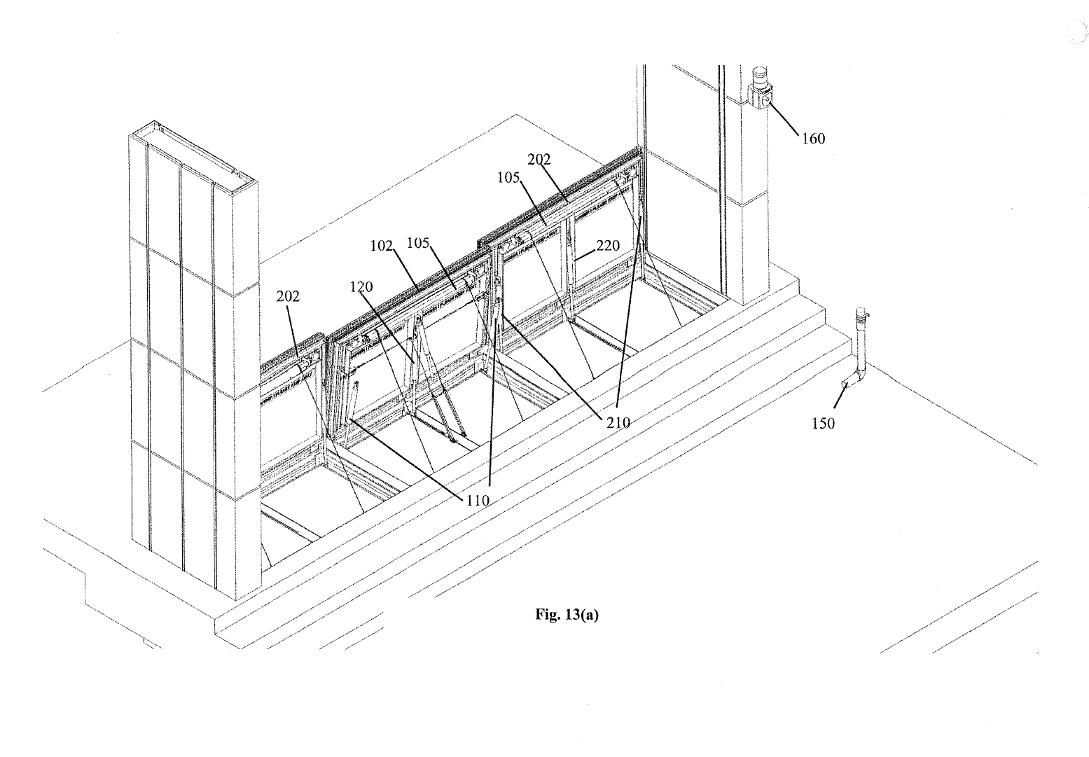

FIG. 11(a) and FIG. 11(b) are perspective views of the floodgate system showing a step of deactivating the gas struts 110 the floodgate 100. In particular, the gas strut fork pins 110a in FIG. 11(a) extend through the gas strut fork and the bracket on the panel 102 to maintain the attachment between the gas struts 110 and the panel 102. As the panel 102 is raised further towards the opened position as shown in FIG. 11(b), the gas strut fork pins 110a are extracted to release the engagement between the gas struts 110 and the panel 102.

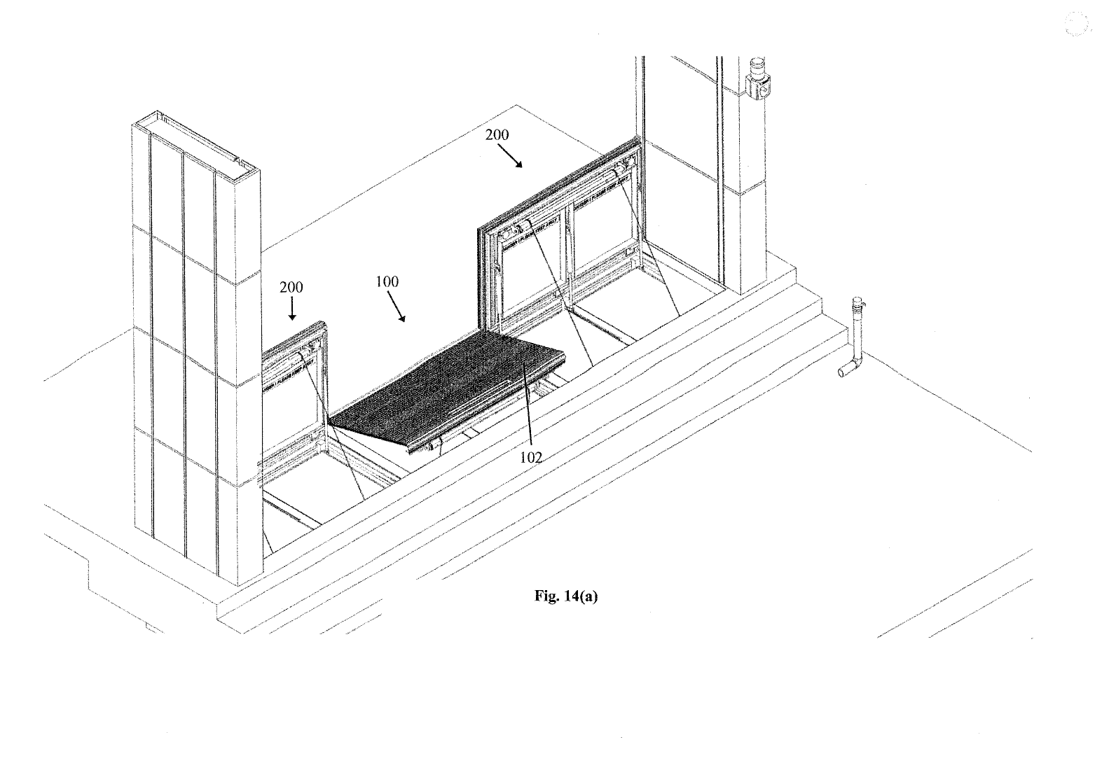

As shown in FIGS. 13(a)-13(b), in use, upon an activation of a sensor 150 as a result of rising water level in front of a building entrance (or a scupper drain located outside a building entrance), an audio and/or visual alarm system 160 will be triggered to broadcast warning messages of the imminent activation of the floodgate to the public. The floodgate system 10 will then be opened to form barrier against intruding flood waters. The sensor 150 may be a conductive water level sensor. Other types of sensors may be used which are known to a skilled person. As described earlier, a deactivation mechanism for the floodgate 100 is activated to disconnect one end of each of the gas struts 110 thereby causing the gas struts 110 to cease to exert a force against the panel 102, upon the panel 102 having been raised to a predetermined position. The panel 102 continues to be raised and held at a fully erected position (such as vertical or substantially vertical) by the gas strut 120. On the other hand, the floodgates 200 are raised to and held at the fully erected position (e.g. the vertical or substantially vertical position) by the three gas struts 210, 220.

As shown in FIGS. 14(a)-(c), during an evacuation, the panel 102 of the floodgate 100 is pushed forward manually to move the panel 102 towards the closed position. This creates an unobstructed passageway for building occupiers to evacuate from the building. Specifically, as an evacuee approaches the floodgate 100 of the floodgate system 10 he/she exerts a pushing force which is about 235N (the weight of 24 kg) to initiate the closing operation of the panel 102 . The panel 102 will then be moved from the opened position towards the closed position while being paused at the intermediate position. Upon the evacuee stepping over/on the panel 102, the panel 102 is closed completely and remains in the locked state as the evacuee (and any subsequent evacuees) continues the evacuation (FIG. 14(b)).

While the invention has been illustrated and described in detail in the drawings and foregoing description, such illustration and description are to be considered illustrative or exemplary, and not restrictive; the invention is not limited to the disclosed embodiments. Other variations to the disclosed embodiments can be understood and effected by those skilled in the art in practicing the claimed invention.

For example, when the floodgate 100 is in the opened position, the panel 102 does not have to be exactly or substantially vertical.

For another example, the deactivation mechanism may be configured to deactivate the gas strut 120 which is disposed at the center of the panel (instead of the gas struts 110). Each of the gas struts 110, 120 may be configured to exert a different force against the panel.

It is also possible to implement gas struts 110 similar to that of the gas strut 130, for example, by arranging gas struts with respect to the floodgate 100 such that when the panel 102 is raised to a predetermined position, the end of the gas strut which abuts against the ground or the base frame is lifted off thereby ceasing to exert a force against the panel. In this case, the gas strut itself and its arrangement with respect to the panel and the ground corporate to function as the deactivation mechanism. Accordingly, gas strut 110 may also function as the safety mechanism of the floodgate for preventing injuries during the closure of the panel.

For another example, the floodgate system 10 comprises a plurality of floodgates 100 (e.g. the floodgates 100 are used in place of 200 in one of the embodiments described above).

1. A floodgate comprising:
a panel configured to be movable between an opened position and a closed position wherein in the opened position, the panel forms a barrier against flood water;
first and second extendable members coupled to the panel to exert a force to move the panel from the closed position towards the opened position about at least one hinge; and
a deactivation mechanism operable to deactivate the first extendable member when the panel is moved from the closed position towards the opened position, thereby reducing a force exerted by the first extendable member against the panel when the panel is moved from the opened position towards the closed position.

2. A floodgate according to claim 1, wherein the deactivation mechanism is operable to cause the first extendable member to cease exerting a force against the panel when the panel is moved from the opened position towards the closed position.

3. A floodgate according to claim 1, wherein the deactivation mechanism is operable to deactivate the first extendable member upon the panel being raised to a pre-determined position between closed position and the opened position.

4. A floodgate according to claim 1, wherein the deactivation mechanism is operable to disengage the first extendable member from the panel.

5. A floodgate according to claim 1, wherein the first extendable member comprises a gas strut.

6. A floodgate according to claim 1, further comprising a safety mechanism arranged with the panel to reduce a speed at which the panel moves from the opened position towards the closed position.

7. A floodgate according to claim 6, wherein the safety mechanism comprises a third extendable member operable to become energized to exert a force against the panel when the panel is moved towards the closed position.

8. A floodgate according to claim 6, wherein the safety mechanism is operable to exert a force against the panel to support the panel at an intermediate position.

9. A floodgate according to claim 7, wherein the third extendable member is the first extendable member.

10. A floodgate according to claim 7, wherein the third extendable member comprises a gas strut.
